(19) United States
(12) Patent Application Publication
(10) Pub. No.: US 2025/0245078 A1
(43) Pub. Date: Jul. 31, 2025

(54) SYSTEMS AND METHODS FOR MANAGING EVENT CORRELATIONS

(71) Applicant: Tata Consultancy Services Limited, Mumbai (IN)

(72) Inventors: SAI CHARAN EMMADI, Hyderabad (IN); PARAG AGRAWAL, Pune (IN); SATYA NARAYANA SAMUDRALA, Pune (IN); VIKRANT VIKAS SHIMPI, Pune (IN); MAITREYA NATU, Pune (IN)

(73) Assignee: Tata Consultancy Services Limited, Mumbai (IN)

(21) Appl. No.: 18/760,678

(22) Filed: Jul. 1, 2024

(30) Foreign Application Priority Data
Jan. 31, 2024 (IN) 202421006529

(51) Int. Cl. G06F 9/54

(52) U.S. Cl. CPC G06F 9/542

(57) ABSTRACT

Existing methodologies apply correlations blindly on the entire event dump leading to many irrelevant correlation signatures and miss out many correlation signatures due to its weak confidence and ignores the events which are observed rarely. These approaches also generate large number of correlation signatures which becomes overwhelming to consume. Embodiments of the present disclosure provide systems and methods for managing event correlations. Events information of an enterprise along with associated timeseries is received and a right correlation scope and a plurality of self-tuned time windows are selected. The correlation scope and the plurality of self-tuned time windows are then used for deriving a plurality of event correlation signatures associated with a set of candidate events. The derived event correlation signatures are then interpreted to obtain a filtered set of event correlation signatures. Each correlation signature from the filtered set of event correlation signatures is mapped to a use case.

### PRIORITY CLAIM

This U.S. patent application claims priority under 35 U.S.C. § 119 to: Indian Patent Application number 202421006529, filed on Jan. 31, 2024. The entire contents of the aforementioned application are incorporated herein by reference.

### TECHNICAL FIELD

The disclosure herein generally relates to event management techniques, and, more particularly, to systems and methods for managing event correlations.

### BACKGROUND

With an increasing focus on digitization and observability, enterprise Information Technology (IT) systems are capturing events and anomalies across various layers of business, applications, and infrastructure. Mining patterns and correlations in these events lead to a plethora of insights to better understand, diagnose, and predict events. While there is a lot of work done in the past on how to efficiently mine event correlations, various real-world aspects still remain unaddressed to bring this theory into practice.

There are system-generated events that are generated by alerting tools on observing anomalies such as “high CPU utilization”, “Service not responding”, etc. Then there are user-reported incidents that capture end-user problems such as “application running slow”, “unable to reset password”, etc. Change requests that capture changes such as “patch update”, “new application installation”, “hardware upgrade”, are also observed. And lastly, there are anomalies captured from activity and error logs.

Analysis of these events can provide powerful insights to better understand the enterprise operations and identify optimization opportunities. One of the most popular levers in this space is event correlation. Different types of correlations have been proposed in the past including attribute-based correlations, temporal correlations, sequence-based methods, and case-based methods. All these techniques have their own strengths and applicability. However, applying this theory into practice presents various real-world challenges as well as opportunities.

One of the most common challenges faced while mining correlations is that it generates a very large number of correlation signatures, many of which are often irrelevant. This usually happens when correlations are computed blindly on the entire event dump. Furthermore, correlation parameters such as correlation time window, minimum support, and minimum correlation confidence, should be adapted based on which events are being correlated, which entities are they coming from, and how are these entities connected to each other. A “one-config-fits-all” does not work most of the time. What is needed is a domain-aware way to select the right scope of events for correlation and to intelligently self-tune these correlation parameters.

The process of deriving correlations in real-world data presents various challenges. For instance: (1) One problem is signature manifests in the form of a large number of correlation signatures which becomes overwhelming to consume. (2) The confidence of many signatures is often not high, which makes it difficult to use these signatures for any concrete action. (3) Many events are inherently rare in nature. Consequently, correlations with high support are not observed. Creative workarounds are required to address such challenges.

Yet another challenge is interpreting the correlation signatures. Correlation signatures can be used in different ways such as alert aggregation, alert prediction, or problem management. Effective heuristics are required to analyze various properties of these signatures to select the right signatures for the right use case.

### SUMMARY

Embodiments of the present disclosure present technological improvements as solutions to one or more of the above-mentioned technical problems recognized by the inventors in conventional systems.

For example, in one aspect, there is provided a processor implemented method for managing event correlations. The method comprises receiving, via one or more hardware processors, a plurality of events pertaining to an enterprise; selecting, via the one or more hardware processors, a correlation scope and a plurality of self-tuned time windows based on the plurality of events, wherein the step of selecting the correlation scope and the plurality of self-tuned time windows comprises: constructing a graph comprising a plurality of entities in the plurality of events and one or more associated interconnections; determining a set of candidate events from the graph; computing one or more parameters of the set of candidate events; applying a heuristic function on the one or more parameters of the set of candidate events for identifying the correlation scope; and recommending the plurality of self-tuned time windows using at least one of the graph and nature associated with the plurality of events; deriving, via the one or more hardware processors, a plurality of event correlation signatures associated with the set of candidate events based on the correlation scope and the plurality of self-tuned time windows; and interpreting, via the one or more hardware processors, the plurality of event correlation signatures to obtain a filtered set of event correlation signatures, wherein each correlation signature from the filtered set of event correlation signatures comprises one or more use cases.

In an embodiment, the heuristic function (i) constructs a matrix corresponding to each of the plurality of events, and wherein the matrix comprises days and number of times an event occurs in each day, and (ii) computes dot product of matrices to identify number of events and the correlation scope.

In an embodiment, the step of recommending the plurality of self-tuned time windows comprises: analyzing timeseries of the plurality of events to determine a multi-model behavior between one or more entities associated with each of the plurality of events; and analyzing and identifying one or more multi-model criteria for each behavior in the timeseries to obtain the plurality of self-tuned time windows, and wherein the step of analyzing and identifying the one or more multi-model criteria is based on one or more attributes of the plurality of events in the timeseries.

In an embodiment, the step of deriving the one or more event correlation signatures comprises: selecting one or more candidate events from the set of candidate events based on the correlation scope and the plurality of self-tuned time windows to obtain one or more associated correlation signatures; and identifying a correlation signature type for each of the one or more associated correlation signatures based on a comparison of an associated confidence value and a confidence threshold.

In an embodiment, the correlation signature type comprises a first correlation signature or a second correlation signature.

In an embodiment, when the correlation signature type is the first correlation signature, the method comprises: identifying a set of pre-conditions based on one or more attributes of the plurality of events to obtain the one or more groups of correlation events, and wherein each group identifies a unique pre-conditional value; and applying the set of pre-conditions on the one or more associated correlation signatures identified as the first correlation signature to increase the associated confidence value.

In an embodiment, when the correlation signature type is the second correlation signature, the method comprises: analyzing the second correlation signature based on a topology comprising a plurality of entities and an associated entity type to increase a correlation support for the second correlation signature.

In an embodiment, the filtered set of event correlation signatures is obtained by: iteratively clustering the plurality of event correlation signatures into one or more groups, until a desired cluster size or one or more grouping criteria is reached, wherein the desired cluster size or the one or more grouping criteria for obtaining the one or more groups is based on one or more constraints comprising at least one of an event direction, an event time window, an associated confidence, an associated size, and an entity relationship; mapping each event correlation signature to at least one use case based on one or more properties of the one or more groups; obtaining a feedback for the plurality of event correlation signatures comprised in the one or more groups; and generating the filtered set of event correlation signatures by adjusting at least one of a time window, a confidence value, and a support based on the feedback.

In another aspect, there is provided a processor implemented system for managing event correlations. The system comprises: a memory storing instructions; one or more communication interfaces; and one or more hardware processors coupled to the memory via the one or more communication interfaces, wherein the one or more hardware processors are configured by the instructions to: receive a plurality of events pertaining to an enterprise; select a correlation scope and a plurality of self-tuned time windows based on the plurality of events by constructing a graph comprising a plurality of entities in the plurality of events and one or more associated interconnections; determining a set of candidate events from the graph; computing one or more parameters of the set of candidate events; applying a heuristic function on the one or more parameters of the set of candidate events for identifying the correlation scope; and recommending the plurality of self-tuned time windows using at least one of the graph and nature associated with the plurality of events; derive a plurality of event correlation signatures associated with the set of candidate events based on the correlation scope and the plurality of self-tuned time windows; and interpret the plurality of event correlation signatures to obtain a filtered set of event correlation signatures, wherein each correlation signature from the filtered set of event correlation signatures comprises one or more use cases.

In an embodiment, the heuristic function (i) constructs a matrix corresponding to each of the plurality of events, and wherein the matrix comprises days and number of times an event occurs in each day, and (ii) computes dot product of matrices to identify number of events and the correlation scope.

In an embodiment, the plurality of self-tuned time windows are recommended by analyzing timeseries of the plurality of events to determine a multi-model behavior between one or more entities associated with each of the plurality of events; and analyzing and identifying one or more multi-model criteria for each behavior in the timeseries to obtain the plurality of self-tuned time windows, and wherein the step of analyzing and identifying the one or more multi-model criteria is based on one or more attributes of the plurality of events in the timeseries.

In an embodiment, the one or more event correlation signatures are derived by selecting one or more candidate events from the set of candidate events based on the correlation scope and the plurality of self-tuned time windows to obtain one or more associated correlation signatures; and identifying a correlation signature type for each of the one or more associated correlation signatures based on a comparison of an associated confidence value and a confidence threshold.

In an embodiment, the correlation signature type comprises a first correlation signature or a second correlation signature.

In an embodiment, when the correlation signature type is the first correlation signature, the one or more hardware processors are further configured by the instructions to identify a set of pre-conditions based on one or more attributes of the plurality of events to obtain the one or more groups of correlation events, wherein each group identifies a unique pre-conditional value; and apply the set of pre-conditions on the one or more associated correlation signatures identified as the first correlation signature to increase the associated confidence value.

In an embodiment, when the correlation signature type is the second correlation signature the one or more hardware processors are further configured by the instructions to analyze the second correlation signature based on a topology comprising a plurality of entities and an associated entity type to increase a correlation support for the second correlation signature.

In an embodiment, the filtered set of event correlation signatures is obtained by: iteratively clustering the plurality of event correlation signatures into one or more groups, until a desired cluster size or one or more grouping criteria is reached, wherein the desired cluster size or the one or more grouping criteria for obtaining the one or more groups is based on one or more constraints comprising at least one of an event direction, an event time window, an associated confidence, an associated size, and an entity relationship; mapping each event correlation signature to at least one use case based on one or more properties of the one or more groups; obtaining a feedback for the plurality of event correlation signatures comprised in the one or more groups; and generating the filtered set of event correlation signatures by adjusting at least one of a time window, a confidence value, and a support based on the feedback.

In yet another aspect, there are provided one or more non-transitory machine-readable information storage mediums comprising one or more instructions which when executed by one or more hardware processors cause managing event correlations by receiving a plurality of events pertaining to an enterprise; selecting a correlation scope and a plurality of self-tuned time windows based on the plurality of events, wherein the step of selecting the correlation scope and the plurality of self-tuned time windows comprises: constructing a graph comprising a plurality of entities in the plurality of events and one or more associated interconnections; determining a set of candidate events from the graph; computing one or more parameters of the set of candidate events; applying a heuristic function on the one or more parameters of the set of candidate events for identifying the correlation scope; and recommending the plurality of self-tuned time windows using at least one of the graph and nature associated with the plurality of events; deriving a plurality of event correlation signatures associated with the set of candidate events based on the correlation scope and the plurality of self-tuned time windows; and interpreting the plurality of event correlation signatures to obtain a filtered set of event correlation signatures, wherein each correlation signature from the filtered set of event correlation signatures comprises one or more use cases.

In an embodiment, the heuristic function (i) constructs a matrix corresponding to each of the plurality of events, and wherein the matrix comprises days and number of times an event occurs in each day, and (ii) computes dot product of matrices to identify number of events and the correlation scope.

In an embodiment, the step of recommending the plurality of self-tuned time windows comprises: analyzing timeseries of the plurality of events to determine a multi-model behavior between one or more entities associated with each of the plurality of events; and analyzing and identifying one or more multi-model criteria for each behavior in the timeseries to obtain the plurality of self-tuned time windows, and wherein the step of analyzing and identifying the one or more multi-model criteria is based on one or more attributes of the plurality of events in the timeseries.

In an embodiment, the step of deriving the one or more event correlation signatures comprises: selecting one or more candidate events from the set of candidate events based on the correlation scope and the plurality of self-tuned time windows to obtain one or more associated correlation signatures; and identifying a correlation signature type for each of the one or more associated correlation signatures based on a comparison of an associated confidence value and a confidence threshold.

In an embodiment, the correlation signature type comprises a first correlation signature or a second correlation signature.

In an embodiment, when the correlation signature type is the first correlation signature, the one or more instructions further cause identifying a set of pre-conditions based on one or more attributes of the plurality of events to obtain the one or more groups of correlation events, and wherein each group identifies a unique pre-conditional value; and applying the set of pre-conditions on the one or more associated correlation signatures identified as the first correlation signature to increase the associated confidence value.

In an embodiment, when the correlation signature type is the second correlation signature, the instructions further cause analyzing the second correlation signature based on a topology comprising a plurality of entities and an associated entity type to increase a correlation support for the second correlation signature.

In an embodiment, the filtered set of event correlation signatures is obtained by: iteratively clustering the plurality of event correlation signatures into one or more groups, until a desired cluster size or one or more grouping criteria is reached, wherein the desired cluster size or the one or more grouping criteria for obtaining the one or more groups is based on one or more constraints comprising at least one of an event direction, an event time window, an associated confidence, an associated size, and an entity relationship; mapping each event correlation signature to at least one use case based on one or more properties of the one or more groups; obtaining a feedback for the plurality of event correlation signatures comprised in the one or more groups; and generating the filtered set of event correlation signatures by adjusting at least one of a time window, a confidence value, and a support based on the feedback.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 depicts an exemplary system for managing event correlations, in accordance with an embodiment of the present disclosure.

FIG. 2 depicts an exemplary flow chart illustrating a method for managing event correlations, using the system of FIG. 1, in accordance with an embodiment of the present disclosure.

FIG. 3 depicts a sequencing diagram illustrating a method for selecting a correlation scope, in accordance with an embodiment of the present disclosure.

FIG. 4 depicts a derivation of correlation window illustrating execution of two (2) jobs, in accordance with an embodiment of the present disclosure.

FIG. 5 depicts a block diagram illustrating a method for deriving the plurality of event correlation signatures, in accordance with an embodiment of the present disclosure.

FIG. 6 depicts clustering of event correlation signatures, in accordance with an embodiment of the present disclosure.

FIG. 7 depicts a classification technique to derive high confidence correlation signatures or a method to increase an associated confidence value of a correlation signature identified as a first correlation signature, in accordance with an embodiment of the present disclosure.

FIG. 8 depicts a method of identifying high coverage correlation signature hidden behind low coverage correlation signatures (also referred as small data correlations signatures/second correlations signature), in accordance with an embodiment of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

As mentioned earlier, with the focus shift on digitization and observability, enterprise Information Technology (IT) systems are capturing events and anomalies across various layers of business, applications, and infrastructure. Mining patterns and correlations in these events lead to a plethora of insights to better understand, diagnose, and predict events. However, various real-world aspects still remain unaddressed to bring this theory into practice.

Existing methodologies apply correlations blindly on the entire event dump leading to many irrelevant correlation signatures. They do not consider the entities from which the events are coming, how are the entities connected and use the same correlation parameters such as correlation time window, minimum support and minimum correlation confidence. These traditional methodologies miss out many correlation signatures due to its weak confidence and ignores the events which are observed rarely. Yet another challenge is interpreting the correlation signatures. Traditional approaches generate large number of correlation signatures which becomes overwhelming to consume. Embodiments of the present disclosure provide systems and methods for managing event correlations. More specifically, upon receiving information pertaining to events of an enterprise along with associated timeseries, a right correlation scope and a plurality of self-tuned time windows are selected. The correlation scope and the plurality of self-tuned time windows are then used for deriving a plurality of event correlation signatures associated with a set of candidate events. The plurality of derived event correlation signatures are then interpreted to obtain a filtered set of event correlation signatures. Each correlation signature from the filtered set of event correlation signatures is mapped to a use case.

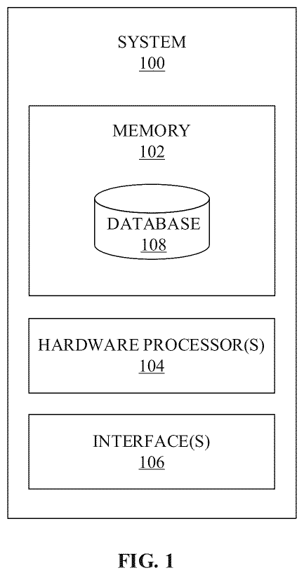

Referring now to the drawings, and more particularly to FIGS. 1 through 8, where similar reference characters denote corresponding features consistently throughout the figures, there are shown preferred embodiments and these embodiments are described in the context of the following exemplary system and/or method.

FIG. 1 depicts an exemplary system 100 for managing event correlations, in accordance with an embodiment of the present disclosure. The system 100 may also be referred to as ‘event correlation management system’, ‘event management system’, ‘management system’, and the like and may be interchangeably used herein. In an embodiment, the system 100 includes one or more hardware processors 104, communication interface device(s) or input/output (I/O) interface(s) 106 (also referred as interface(s)), and one or more data storage devices or memory 102 operatively coupled to the one or more hardware processors 104. The one or more processors 104 may be one or more software processing components and/or hardware processors. In an embodiment, the hardware processors can be implemented as one or more microprocessors, microcomputers, microcontrollers, digital signal processors, central processing units, state machines, logic circuitries, and/or any devices that manipulate signals based on operational instructions. Among other capabilities, the processor(s) is/are configured to fetch and execute computer-readable instructions stored in the memory. In an embodiment, the system 100 can be implemented in a variety of computing systems, such as laptop computers, notebooks, hand-held devices (e.g., smartphones, tablet phones, mobile communication devices, and the like), workstations, mainframe computers, servers, a network cloud, and the like.

The I/O interface device(s) 106 can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 102 may include any computer-readable medium known in the art including, for example, volatile memory, such as static random-access memory (SRAM) and dynamic-random access memory (DRAM), and/or non-volatile memory, such as read only memory (ROM), erasable programmable ROM, flash memories, hard disks, optical disks, and magnetic tapes. In an embodiment, a database 108 is comprised in the memory 102, wherein the database 108 comprises information a plurality of events and associated timeseries pertaining to one or more enterprises, correlation scope, self-tuned time windows being derived from one or more candidate events identified from the plurality of events, and the like. The database 108 further comprises a plurality of event correlation signatures that are interpreted to obtain filtered set of event correlation signatures, mapped data pertaining to the filtered set of event correlation signatures and use case(s). The memory 102 further comprises (or may further comprise) information pertaining to input(s)/output(s) of each step performed by the systems and methods of the present disclosure. In other words, input(s) fed at each step and output(s) generated at each step are comprised in the memory 102 and can be utilized in further processing and analysis.

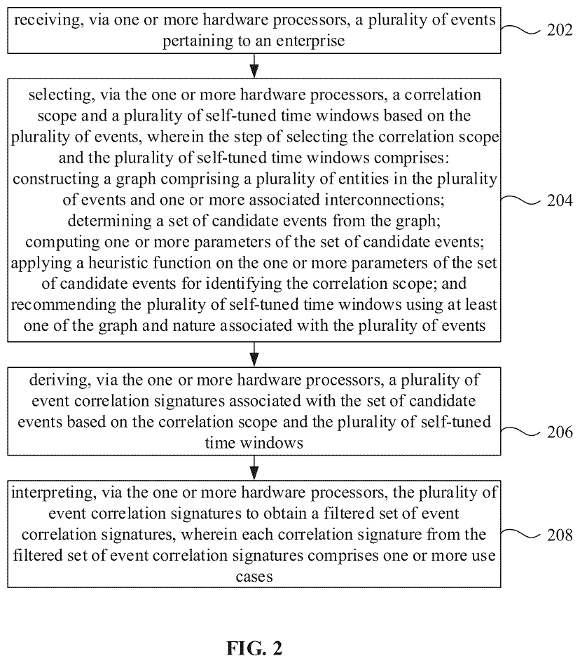

FIG. 2, with reference to FIG. 1, depicts an exemplary flow chart illustrating a method for managing event correlations, using the system 100 of FIG. 1, in accordance with an embodiment of the present disclosure. In an embodiment, the system(s) 100 comprises one or more data storage devices or the memory 102 operatively coupled to the one or more hardware processors 104 and is configured to store instructions for execution of steps of the method by the one or more processors 104. The steps of the method of the present disclosure will now be explained with reference to components of the system 100 of FIG. 1, and the flow diagram as depicted in FIG. 2. Although process steps, method steps, techniques or the like may be described in a sequential order, such processes, methods, and techniques may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

At step 202 of the method of the present disclosure, the one or more hardware processors 104 receive a plurality of events (also referred to as ‘events’ and interchangeably used herein) pertaining to an enterprise. The events occur between a plurality of entities (e.g., say servers, databases, cloud, or any other Information Technology (IT) system/component). Such events may include, for example, transmission of a message from one entity to another, performing an action in one entity to reflect a desired outcome in a second entity, and so on.

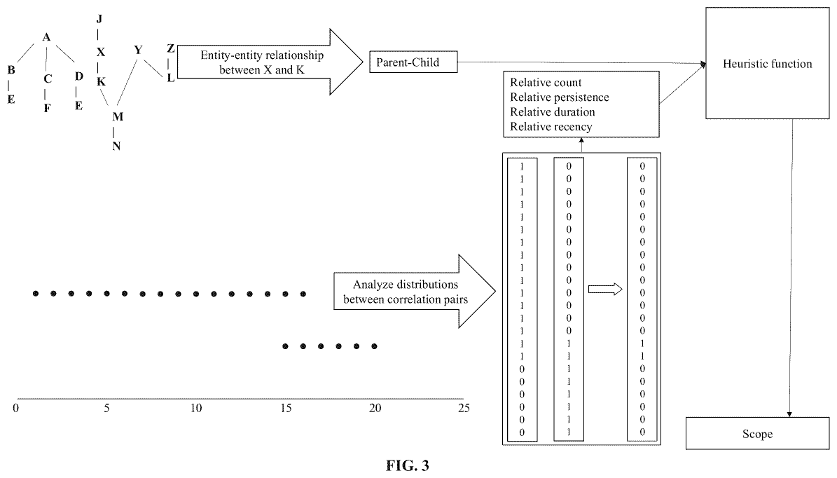

At step 204 of the method of the present disclosure, the one or more hardware processors 104 select a correlation scope and a plurality of self-tuned time windows based on the plurality of events. FIG. 3, with reference to FIGS. 1-2, depicts a sequencing diagram illustrating a method for selecting a correlation scope, in accordance with an embodiment of the present disclosure. A one-dimensional matrix is created for each event type with each value representing the number of events observed in a day. The correlation scope is then identified using the following formula Correlation scope [Date]=minimum of (Event A [Date], Event B [Date], . . . ).

The step of selecting the correlation scope and the plurality of self-tuned time windows includes constructing a graph comprising a plurality of entities in the plurality of events and one or more associated interconnections. From the graph, a set of candidate events are determined. Further, one or more parameters of the set of candidate events are computed. For instance, the one or more parameters include, but are not limited to, recency, persistence, count, duration, and the like. A heuristic function is then applied on the one or more parameters of the set of candidate events for identifying the correlation scope. The heuristic function (i) constructs a matrix corresponding to each of the plurality of events, and wherein the matrix comprises days and number of times an event occurs in each day, and (ii) computes dot product of matrices to identify number of events and the correlation scope. The above step of computing the parameters is better understood by way of following description.

More specifically, the parameters may be computed as follows: A one dimensional matrix for each event with each value representing the number of events observed in a day is created. Dot product between matrices is computed to identify possible correlation scope. A relative count refers to number of events in the possible correlation scope. A relative persistence refers to number of unique days in the possible correlation scope. A relative recency refers to number of days last observed possible correlation. A relative duration refers to relative duration of the possible correlation scope. The plurality of self-tuned time windows is then recommended using at least one of the graph and nature associated with the plurality of events.

The first challenge is to select the right data and self-tuned time windows to mine correlations. Failing to do so leads to too many or too few correlations. Instead of mining correlations across all events, the relevance of correlation signatures increases significantly by selecting the scope to mine correlations. The system 100 uses the topological information to derive influencers and select events of only these influencer nodes to mine correlations. For instance, the system 100 correlates the “server down” events of server S1 only with the events of services hosted on that server or the applications that use these services. The system 100 captures the entity interconnections in the form of a graph and use graph algorithms such as connected components and cliques to mine relevant entities to mine correlations.

Instead of using fixed time windows for mining correlations, the system 100 recommends the self-tuned time windows that adapt based on the topology and the nature of events. The basic idea of system 100 is to assess how long it takes for an event on one entity to cause another event on another entity. To understand this propagation time, the system 100 taps into the underlying logs of these entities and computes the lag time between these activities.

It is to be noted that, in cases where the lag time demonstrates multimodality, the same pair of events may exhibit different lag time distributions and hence may need different correlation windows. The system 100 and the method implement one or more classification algorithms (as known in the art) to assess various attributes such as day of week, day of month, severity, priority, etc. to best explain any multi-modality in this behavior. Next, for each mode, the system 100 computes a representative threshold using statistical measures such as mean and standard deviation and use that as the time window for mining correlations.

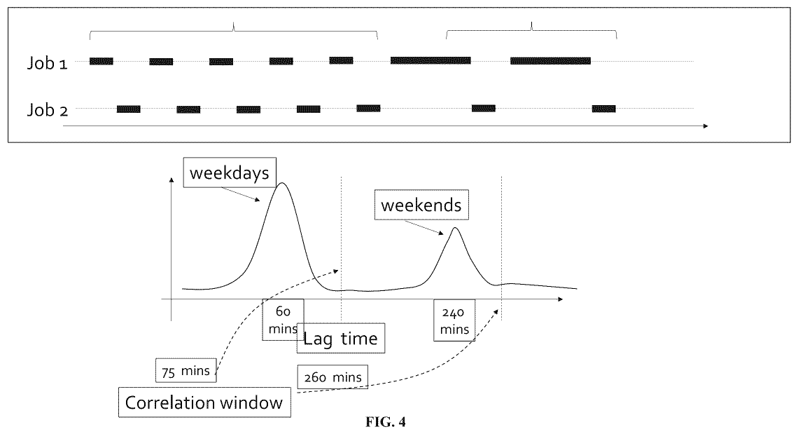

For instance, consider a sequence of batch jobs A and B such that Job A precedes Jobs B. FIG. 4, with reference to FIGS. 1 through 3, depicts a derivation of correlation window illustrating execution of two (2) jobs, in accordance with an embodiment of the present disclosure. This distribution demonstrates a multi-modal behavior with low lag time of 60 mins and high lag time of 240 mins. Classification shows that the low lag time is observed on weekdays and high lag time is explained by weekends. FIG. 4 further shows the recommended correlation window of 75 mins and 260 mins for weekdays and weekends respectively (also referred to as self-tuned time windows). The step of recommending the self-tuned time windows includes analyzing timeseries of the plurality of events to determine a multi-model behavior between one or more entities associated with each of the plurality of events. Further, one or more multi-model criteria are analyzed and identified for each behavior in the time series to obtain the plurality of self-tuned time windows as shown in FIG. 4. The step of analyzing and identifying one or more multi-model criteria is based on one or more attributes of the plurality of events in the timeseries.

At step 206 of the method of the present disclosure, the one or more hardware processors 104 deriving a plurality of event correlation signatures associated with the set of candidate events based on the correlation scope and the plurality of self-tuned time windows. One or more candidate events from the set of candidate events are selected based on the correlation scope and the plurality of self-tuned time windows to obtain one or more associated correlation signatures. A correlation signature type for each of the one or more associated correlation signatures based on a comparison of an associated confidence value and a confidence threshold. The confidence value represents the percentage of correlated events among total number of events. This confidence value is computed using the following formula as given below by way of following equation:

$$Confidence Value = ( Number of correlated events ) / ( Total number of correlated events ) .$$

For example, if there are 100 events of High CPU and 100 events of URL failure and say, CONFIDENCE THRESHOLD is set as 90. Say, 92 High CPU events correlate with 92 events of URL failure, confidence value is computed as=(194/200)=92% (>confidence threshold). Hence, the system 100 calls (High CPU, URL failure) as correlation. The correlation signature type comprises a first correlation signature (e.g., a low confidence correlation signature) or a second correlation signature (e.g., small data correlation signature). When the correlation signature type is the first correlation signature (or of the type such as low confidence correlation signature), the system 100 identifies a set of pre-conditions based on one or more attributes of the plurality of events to obtain the one or more groups of correlation events. Each group identifies a unique pre-conditional value. The set of pre-conditions are then applied on the one or more associated correlation signatures identified as the first correlation signature to increase the associated confidence value.

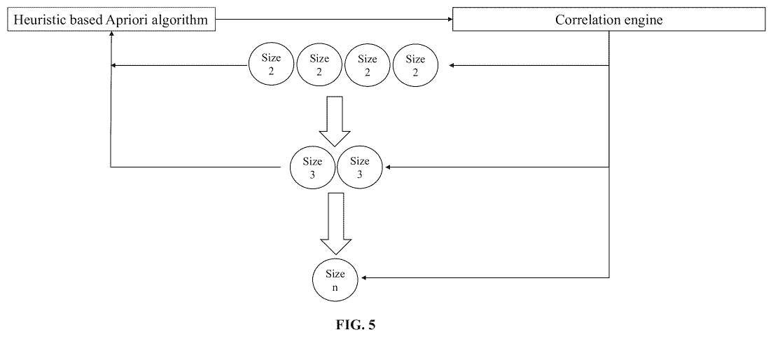

In case, the correlation signature type is the second correlation signature (or of the type such as small data correlation signature), the system 100 analyzes the second correlation signature based on a topology comprising a plurality of entities and an associated entity type to increase a correlation support for the second correlation signature. FIG. 5, with reference to FIGS. 1 through 4, depicts a block diagram illustrating a method for deriving the plurality of event correlation signatures, in accordance with an embodiment of the present disclosure. Once the correlation scope is determined, system 100 identifies the event pairs which need to be analyzed for correlation. Each event pair is analyzed for correlation using the right correlation parameters-time window, confidence, support, and so on. After identifying the event pairs with correlation, now using heuristic based apriori algorithm (as known in the art), the system 100 identifies all the possible event groups of next size (here it is size 3). For every possible event correlation of next size, a heuristic score is computed to identify number of sub-set event groups are also correlating. Consider a scenario, say AB, BC, AC are correlations of size 2. For computing correlations of size-3, possible correlation is ABC. Here, the heuristic score of ABC is 3 (AB, BC, AC all are correlations). Hence, ABC is analyzed further for correlation.

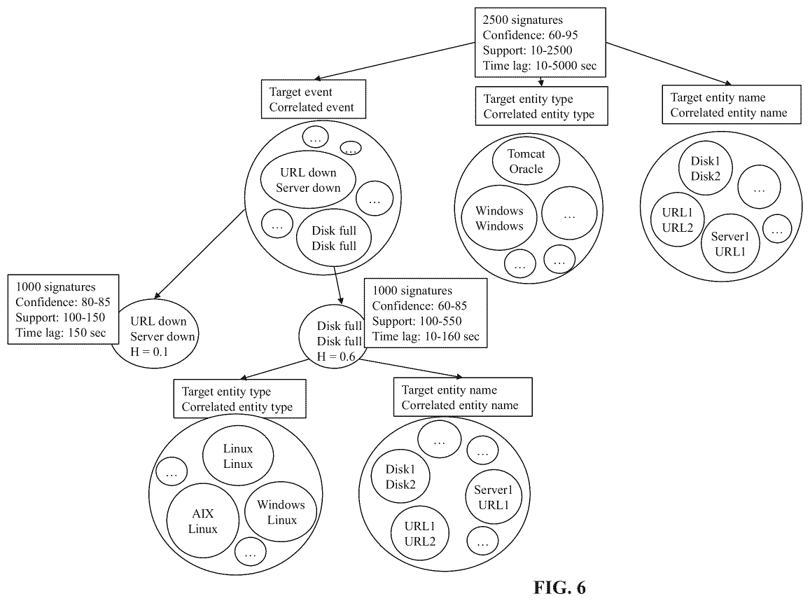

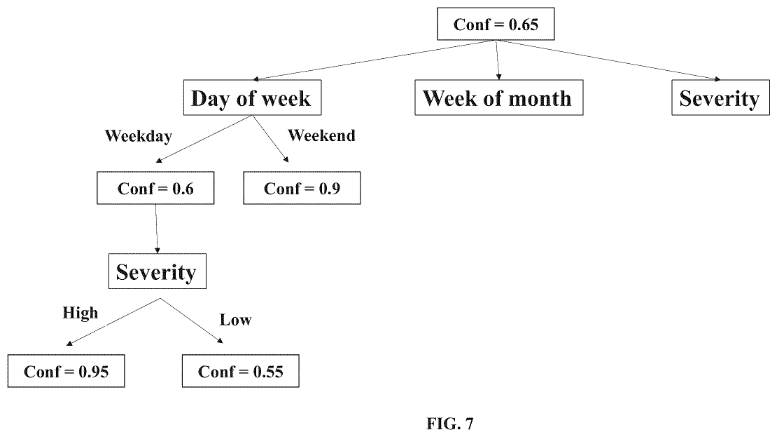

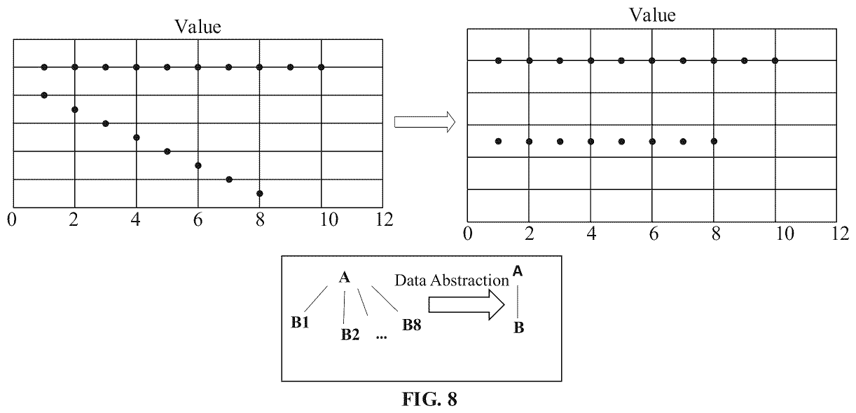

In another scenario, if XY, YZ are correlations of size-2. For computing correlations of size 3, possible correlation is XYZ. Here heuristic score of XYZ is 2 (XY, YZ are correlations). Hence, XYZ is not analyzed further for correlation. Further, only those groups which have all the subset groups as co-occurring are considered to analyze further. The above steps are repeated further to identify maximum possible co-occurring groups. The process of deriving correlations or correlation signatures presents another challenge, and this is better understood by way of the following description. Following are some of the frequently faced issues:
1. Too many signatures: It was observed by the system 100 that one fault often leads to many symptoms, and this results in a large number of related signatures. Grouping such signatures can significantly reduce signature fatigue. A correlation signature consists of attributes such as entity type, entity name, event name, timestamp of two or more events. These attributes are used to create clusters of signatures with similar properties of support, confidence, and lead time. FIG. 6, with reference to FIGS. 1 through 5, depicts clustering of event correlation signatures, in accordance with an embodiment of the present disclosure. Possible levers are identified to form the groups-time lag, direction, confidence, coverage, entity name, type, event, etc. The best lever among possible levers is identified by analyzing the distribution of number of data points in each cluster, and this lever is used with highest entropy. More specifically, FIG. 6 shows an example of how 2,500 correlation signatures can be grouped. The system 100 creates clusters of these correlation signatures by event types, by entity types, and by entity names. The system 100 then uses correlation confidence and support as the metrics to make clusters and assess the quality of clusters using Silhouette index. In FIG. 6, system 100 identifies 1000 signatures identified as {URL down, Server down} signature, all of which have similar correlation properties which is identified as a cluster with low entropy of 0.1. The example shows that the {Disk full, Disk full} cluster is not uniform enough and has a high entropy of 0.6. Hence, the system 100 uses entity types to further deep-dive and select {AIX+Disk full, Linux+Disk full} as the next cluster of 500 signatures which has a low entropy of 0.2. The system 100 and method can thus reduce the signature fatigue of 1500 signatures by grouping them into few homogeneous clusters.
2. Low confidence correlation signatures: Real-world data often generates many low confidence signatures. Such low confidence correlation signatures make a weak case for deriving any meaningful insights or taking actionable recommendations. However, the system 100 observed that high-confidence signatures are often hidden within these low-confidence signatures. They just need to be extracted by applying the right filters of space or time. The system 100 applies classification algorithms on various ticket attributes such as severity, priority, day of month, hour of day, day of week, location, etc. to find the set of pre-conditions that increase the correlation confidence. Consider the example in FIG. 7. More specifically, FIG. 7, with reference to FIGS. 1 through 6, depicts a classification technique to derive high confidence correlation signatures or a method to increase an associated confidence value of a correlation signature identified as the first correlation signature, in accordance with an embodiment of the present disclosure. Using one or many of the following attributes, the system 100 identifies the set of pre-conditions using which are used for forming groups of event correlations with each group identifying unique pre-conditional value. If the confidence is improved, the system 100 considers the pre-condition and scope down the correlation signature (e.g., Hour of Day, Day of week, Day of month, severity, priority, entity location, etc.). As can be depicted in FIG. 7, the correlation confidence of a signature is 0.65. However, if the system 100 classifies the events by weekday and weekends, then the correlation confidence for weekends increases to 0.9. Further deep dive also shows that for the same signature, the correlation confidence on weekdays for high severity tickets is 0.95.
3. Small data correlation signatures (e.g., also referred as second correlation signature): Many events are rare in nature such as high severity outages, data center shutdowns. By nature, they take place a few times a year. Mining correlations in such rare events does not lead to statistically significant insights. To analyze these events, creative workarounds are required such as abstractions, data inversions, data augmentation. FIG. 8, with reference to FIGS. 1 through 7, depicts a method of identifying high coverage correlation signature hidden behind low coverage correlation signatures (also referred as small data correlations signatures/second correlations signature), in accordance with an embodiment of the present disclosure. More specifically, as depicted in FIG. 8, when the correlation signature type is the second correlation signature, the system 100 analyzes the second correlation signature based on a topology comprising a plurality of entities and an associated entity type to increase a correlation support for the second correlation signature.

Referring to steps of FIG. 2, at step 208 of the method of the present disclosure, the one or more hardware processors 104 interpret the plurality of event correlation signatures to obtain a filtered set of event correlation signatures. Each correlation signature from the filtered set of event correlation signatures comprises one or more use cases. The filtered set of event correlation signatures is obtained by iteratively clustering the plurality of event correlation signatures into one or more groups, until a desired cluster size or one or more grouping criteria is reached. The desired cluster size or the one or more grouping criteria for obtaining the one or more groups is based on one or more constraints comprising at least one of an event direction, an event time window, an associated confidence, an associated size, and an entity relationship. Further, each event correlation signature is mapped to at least one use case based on one or more properties of the one or more groups. The one or more properties include, but are not limited to, Prediction-High Time windows, High Confidence Aggregation-Low Time windows, High Confidence, Problem Signatures-High Time windows, High signature size, Strong direction in the correlation, and the like. One the mapping is done, a feedback is obtained for the plurality of event correlation signatures comprised in the one or more groups. Based on the feedback, the filtered set of event correlation signatures are generated. For instance, the feedback may include, but are not limited to, adjusting at least one of a time window, a confidence value, and a support (e.g., number of instances where the correlation is observed).

The above step of interpreting the plurality of event correlation signatures may be better understood by way of following description:

Correlation signatures can be used in different ways based on various properties. For instance,
1. Alert aggregation: a fault often generates many symptoms. These symptoms manifest in the form of events. The command center teams treat each event in isolation and end up putting a lot of redundant efforts. Correlation signatures can help aggregate such related alerts and thus reduce alert fatigue for command center teams. Correlation signatures with the following properties are ideal candidates for alert aggregation.
   a. The correlated events should occur within a short time window such that the incoming alerts can be grouped together to act on.
   b. The entities of the correlated events should be structurally related such that the correlations have semantic significance.
2. Alert prediction: many situations gradually turn from bad to worse and they give early signals of potential future problems. For instance, the increasing trend in enqueue rate, followed by increasing queue length, are strong early indicators of future message drops. Correlations signatures can be used to predict and give early warnings of such scenarios. Correlation signatures with the following properties can be ideal candidates for alert prediction.
   a. The correlation should have a strong sense of direction. Correlation between event types A and B can be used for prediction if A always occurs before B.
   b. The correlated events should occur within a relatively longer time-window such that early signals are helpful in taking any preventive actions. The time-window should be longer than the mean time to prevent the predicted incident.
3. Problem signature mining: when the same incident occurs multiple times then a common practice is to create a problem ticket for such issues and diagnose its cause and provide corrective actions to eliminate them. For instance, consider a scenario where a URL frequently observes high response time. Most often the cause is that the Oracle® listener service stops running, which happens because the filesystem gets full, which usually happens when backups are initiated. Correlations can provide a fantastic tool to capture these problem signatures and narrow down the root cause. Correlations signatures with the following properties can ideal candidates for problem management:
   a. The correlation should have a high support indicating that the issue has occurred sufficient times to initiate a problem management.
   b. The correlated events may occur within a large time window as it takes time for the fault to manifest across different levels of tech-stack.
   c. The correlation signature may not have high confidence when observed as a whole, but same signature shows strong correlations under different preconditions. This usually happens because the same issue may get triggered by more than one causes, and these causes may or may not manifest together. For instance, consider a hypothetical scenario that an application frequently observes availability issues but on weekdays this is caused due to memory issues, and on weekdays it is caused due to network issues. As a result, overall, high correlation confidence may not be observed, but it may demonstrate strong weekday/weekend patterns and stronger correlations when weekdays and weekends are analyzed in isolation. If the correlation signature shows a strong sense of direction, then it also helps to mine a sequence from cause to symptoms assisting in the root-cause analysis.

### Results:

The system 100 applies the method of FIG. 2 to IT operations of an enterprise (e.g., say life insurance company). The system 100 analyzed X tickets (e.g., 330,662 tickets) generated in one month from Y entity types (e.g., say 14 entity types) such as Windows, Linux, Oracle, 753 unique entities, and 1355 unique issues such as high CPU utilization, API service down, etc. The objective of this was to reduce the alert fatigue by finding opportunities to aggregate redundant alerts, eliminate recurring alerts, and give early warnings of potential future alerts.

### Selecting the Right Correlation Scope and Self-Tuned Time Windows:

The system 100 first captured relationships between entities such as hosted on, accessed by, shared with, etc. The system 100 then used these relationships to derive spatio-temporal correlations by considering only influencing entities to mine correlations. For example, the system 100 correlated “Server down” events with the “CPU” and “memory” events of that server and the “URL down” events of the applications hosted on that server.

Appropriate self-tune time windows for confidence, support, and correlation time window were applied based on the nature of event occurrence, and their degree of separation. For example, the system 100 observed that four applications share one common server. The “high memory utilization” issues on this server can be observed due to “high request rate” on any of these four applications. Hence, the system 100 used moderate confidence and moderate support to mine these correlations. It took around 7 mins for high request count to lead to high memory utilization, hence the system 100 set a correlation window of 7 minutes.

The following challenges were addressed during derivation of event correlation signatures:

The system 100 observed 116 event correlation signatures. These signatures had an average confidence of 84, average support of 4986, average persistence of 18 days, and average time window of 7 mins.

The system 100 addressed the case of too many signatures by forming group signatures. 55 correlations of 2 event types, 19 correlation signatures of 3 event types, 26 correlation signatures of 4 event types, 15 correlation signatures of 5 event types, and 1 correlation signature of 9 event types were formed.

Some cases of small data events were also observed, which were addressed by performing abstraction on entity type level and correlating them across entity levels. Some cases of low confidence signatures were also observed, but on specific temporal patterns, a strong confidence was observed.

Interpreting event correlation signatures: Below presented is on how the event correlation signatures led to recommendations to improve enterprise IT operations.

Alert aggregation: 32 event correlation signatures were identified that can be used to group related alerts. These signatures had a strong confidence of >90%, a short correlation time window of <1 minute, and moderate support with more than 10 occurrences. For example: the system 100 observed that an application generated 4 different alerts, viz. “UI service down”, “API service down”, “Location service down”, “Dashboard service down”, within one minute span. This pattern has been observed 25 times in the past one month. Aggregation of these alerts reduced 225 tickets to 25 tickets. 32 such correlation signatures were identified which can reduce 221,369 tickets to 21,381 tickets, leading to 90% reduction in the ticket volume.

Alert prediction: 17 event correlation signatures that can be used to predict future alerts were identified. These signatures have a strong confidence of >80%, a strong directional correlation, and a look-ahead time>20 mins. These signatures provide a look-ahead time of at least 20 minutes to act. For example, it was observed that an event “NodeJS cluster memory reservation of 50% is crossed” occurs 26 times, and 24 of 26 times it led to the event “Unhealthy host on AWS application” within a time span of 28 minutes. This signature can be used to generate a future warning of an AWS application host failure. 17 such signatures were identified, which can give 18,241 early warnings.

Problem signature mining: 84 correlation signatures that can be used to mine problem signatures were identified. These signatures had a moderate confidence of >70% and a correlation time window ranging up to 35 minutes. For example, the system 100 observed event of “Burst of write requests”. 12 minutes after this event, the system 100 observed the events “Warning that storage are nearing full”, “CPU utilization beyond the threshold”, and “Average response time increased”. 15 minutes after this event “SQL server stopped working” was observed by the system 100. Taking corrective action on write requests can eliminate all these tickets which account to 8,136 tickets in one month.

It is to be noted by a person having ordinary skill in the art or person skilled in the art that some problem signatures only point at cooccurring symptoms and do not point to the root-cause. 33 such signatures were found by the system 100. For example, the system 100 observed that for multiple application, “development instance down”, and “UAT instance down” takes place within a span of 32 minutes. The system 100 observed this pattern for 4 applications and saw 2,225 such tickets over a period of one month. Further analysis of these events may point to common resources used by these instances. Taking corrective action on these resources can eliminate 1,590 such events. 84 signatures were identified to initiate problem management to potentially eliminate 236,748 tickets.

The system 100 and method of the present disclosure proposed to first use the 84 problem signatures to eliminate tickets, and then use the 32 aggregation signatures to reduce the alert volume by grouping related alerts.

Managing event correlation provides a powerful lever to analyze the events data to better manage the enterprise IT systems. While many event correlation algorithms are present in literature but applying them in practice presents many real-world challenges. The disclosure presented observations, challenges, and workarounds and the opportunities in using the method of the present disclosure for event correlations in enterprise IT systems. The results showed that event correlations can be used to group 221,369 alerts, predict 18,241 alerts, and eliminate 236,748 alerts.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g., an ASIC and an FPGA, or at least one microprocessor and at least one memory with software processing components located therein. Thus, the means can include both hardware means and software means. The method embodiments described herein could be implemented in hardware and software. The device may also include software means. Alternatively, the embodiments may be implemented on different hardware devices, e.g., using a plurality of CPUs.

The embodiments herein can comprise hardware and software elements. The embodiments that are implemented in software include but are not limited to, firmware, resident software, microcode, etc. The functions performed by various components described herein may be implemented in other components or combinations of other components. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, comprising:
receiving, via one or more hardware processors, a plurality of events pertaining to an enterprise;
selecting, via the one or more hardware processors, a correlation scope and a plurality of self-tuned time windows based on the plurality of events, wherein the step of selecting the correlation scope and the plurality of self-tuned time windows comprises:
constructing a graph comprising a plurality of entities in the plurality of events and one or more associated interconnections;
determining a set of candidate events from the graph;
computing one or more parameters of the set of candidate events;
applying a heuristic function on the one or more parameters of the set of candidate events for identifying the correlation scope; and
recommending the plurality of self-tuned time windows using at least one of the graph and nature associated with the plurality of events;
deriving, via the one or more hardware processors, a plurality of event correlation signatures associated with the set of candidate events based on the correlation scope and the plurality of self-tuned time windows; and
interpreting, via the one or more hardware processors, the plurality of event correlation signatures to obtain a filtered set of event correlation signatures, wherein each correlation signature from the filtered set of event correlation signatures comprises one or more use cases.

2. The processor implemented method of claim 1, wherein the heuristic function (i) constructs a matrix corresponding to each of the plurality of events, and wherein the matrix comprises days and number of times an event occurs in each day, and (ii) computes dot product of matrices to identify number of events and the correlation scope.

3. The processor implemented method of claim 1, wherein the step of recommending the plurality of self-tuned time windows comprises:
analyzing timeseries of the plurality of events to determine a multi-model behavior between one or more entities associated with each of the plurality of events; and
analyzing and identifying one or more multi-model criteria for each behavior in the timeseries to obtain the plurality of self-tuned time windows, and wherein the step of analyzing and identifying the one or more multi-model criteria is based on one or more attributes of the plurality of events in the timeseries.

4. The processor implemented method of claim 1, wherein the step of deriving the one or more event correlation signatures comprises:
selecting one or more candidate events from the set of candidate events based on the correlation scope and the plurality of self-tuned time windows to obtain one or more associated correlation signatures; and
identifying a correlation signature type for each of the one or more associated correlation signatures based on a comparison of an associated confidence value and a confidence threshold.

5. The processor implemented method of claim 4, wherein the correlation signature type comprises a first correlation signature or a second correlation signature.

6. The processor implemented method of claim 5, wherein when the correlation signature type is the first correlation signature, the method comprises:
identifying a set of pre-conditions based on one or more attributes of the plurality of events to obtain the one or more groups of correlation events, and wherein each group identifies a unique pre-conditional value; and
applying the set of pre-conditions on the one or more associated correlation signatures identified as the first correlation signature to increase the associated confidence value.

7. The processor implemented method of claim 5, when the correlation signature type is the second correlation signature, the method comprises:
analyzing the second correlation signature based on a topology further comprising a plurality of entities and an associated entity type to increase a correlation support for the second correlation signature.

8. The processor implemented method of claim 1, wherein the filtered set of event correlation signatures is obtained by:
iteratively clustering the plurality of event correlation signatures into one or more groups, until a desired cluster size or one or more grouping criteria is reached, wherein the desired cluster size or the one or more grouping criteria for obtaining the one or more groups is based on one or more constraints further comprising at least one of an event direction, an event time window, an associated confidence, an associated size, and an entity relationship;
mapping each event correlation signature to at least one use case based on one or more properties of the one or more groups;
obtaining a feedback for the plurality of event correlation signatures comprised in the one or more groups; and
generating the filtered set of event correlation signatures by adjusting at least one of a time window, a confidence value, and a support based on the feedback.

9. A system (100), comprising:
a memory (102) storing instructions;
one or more communication interfaces (106); and
one or more hardware processors (104) coupled to the memory via the one or more communication interfaces (106), wherein the one or more hardware processors (104) are configured by the instructions to:
receive a plurality of events pertaining to an enterprise;
select a correlation scope and a plurality of self-tuned time windows based on the plurality of events, wherein the correlation scope and the plurality of self-tuned time windows are selected by:
constructing a graph further comprising a plurality of entities in the plurality of events and one or more associated interconnections;
determining a set of candidate events from the graph;
computing one or more parameters of the set of candidate events;
applying a heuristic function on the one or more parameters of the set of candidate events for identifying the correlation scope; and
recommending the plurality of self-tuned time windows using at least one of the graph and nature associated with the plurality of events;
derive a plurality of event correlation signatures associated with the set of candidate events based on the correlation scope and the plurality of self-tuned time windows; and
interpret the plurality of event correlation signatures to obtain a filtered set of event correlation signatures, wherein each correlation signature from the filtered set of event correlation signatures comprises one or more use cases.

10. The system of claim 9, wherein the heuristic function (i) constructs a matrix corresponding to each of the plurality of events, and wherein the matrix comprises days and number of times an event occurs in each day, and (ii) computes dot product of matrices to identify number of events and the correlation scope.

11. The system of claim 9, wherein the plurality of self-tuned time windows are recommended by:
analyzing timeseries of the plurality of events to determine a multi-model behavior between one or more entities associated with each of the plurality of events; and
analyzing and identifying one or more multi-model criteria for each behavior in the timeseries to obtain the plurality of self-tuned time windows, and wherein the step of analyzing and identifying the one or more multi-model criteria is based on one or more attributes of the plurality of events in the timeseries.

12. The system of claim 9, wherein the one or more event correlation signatures are derived by:
selecting one or more candidate events from the set of candidate events based on the correlation scope and the plurality of self-tuned time windows to obtain one or more associated correlation signatures; and
identifying a correlation signature type for each of the one or more associated correlation signatures based on a comparison of an associated confidence value and a confidence threshold.

13. The system of claim 12, wherein the correlation signature type comprises a first correlation signature or a second correlation signature.

14. The system of claim 13, wherein when the correlation signature type is the first correlation signature, the one or more hardware processors are further configured by the instructions to:
identify a set of pre-conditions based on one or more attributes of the plurality of events to obtain the one or more groups of correlation events, and wherein each group identifies a unique pre-conditional value; and
apply the set of pre-conditions on the one or more associated correlation signatures identified as the first correlation signature to increase the associated confidence value.

15. The system of claim 13, wherein when the correlation signature type is the second correlation signature, the one or more hardware processors are further configured by the instructions to
analyzing the second correlation signature based on a topology further comprising a plurality of entities and an associated entity type to increase a correlation support for the second correlation signature.

16. The system of claim 9, wherein the filtered set of event correlation signatures is obtained by:
iteratively clustering the plurality of event correlation signatures into one or more groups, until a desired cluster size or one or more grouping criteria is reached, wherein the desired cluster size or the one or more grouping criteria for obtaining the one or more groups is based on one or more constraints further comprising at least one of an event direction, an event time window, an associated confidence, an associated size, and an entity relationship;
mapping each event correlation signature to at least one use case based on one or more properties of the one or more groups;
obtaining a feedback for the plurality of event correlation signatures comprised in the one or more groups; and
generating the filtered set of event correlation signatures by adjusting at least one of a time window, a confidence value, and a support based on the feedback.

17. One or more non-transitory machine-readable information storage mediums comprising one or more instructions which when executed by one or more hardware processors cause:
receiving a plurality of events pertaining to an enterprise;
selecting a correlation scope and a plurality of self-tuned time windows based on the plurality of events, wherein the step of selecting the correlation scope and the plurality of self-tuned time windows comprises:
constructing a graph further comprising a plurality of entities in the plurality of events and one or more associated interconnections;
determining a set of candidate events from the graph;
computing one or more parameters of the set of candidate events;
applying a heuristic function on the one or more parameters of the set of candidate events for identifying the correlation scope; and
recommending the plurality of self-tuned time windows using at least one of the graph and nature associated with the plurality of events;
deriving a plurality of event correlation signatures associated with the set of candidate events based on the correlation scope and the plurality of self-tuned time windows; and
interpreting the plurality of event correlation signatures to obtain a filtered set of event correlation signatures, wherein each correlation signature from the filtered set of event correlation signatures comprises one or more use cases.

18. The one or more non-transitory machine-readable information storage mediums of claim 17, wherein the heuristic function (i) constructs a matrix corresponding to each of the plurality of events, and wherein the matrix comprises days and number of times an event occurs in each day, and (ii) computes dot product of matrices to identify number of events and the correlation scope,
wherein the step of recommending the plurality of self-tuned time windows comprises:
analyzing timeseries of the plurality of events to determine a multi-model behavior between one or more entities associated with each of the plurality of events; and
analyzing and identifying one or more multi-model criteria for each behavior in the timeseries to obtain the plurality of self-tuned time windows, and wherein the step of analyzing and identifying the one or more multi-model criteria is based on one or more attributes of the plurality of events in the timeseries,
wherein the step of deriving the one or more event correlation signatures comprises:
selecting one or more candidate events from the set of candidate events based on the correlation scope and the plurality of self-tuned time windows to obtain one or more associated correlation signatures; and
identifying a correlation signature type for each of the one or more associated correlation signatures based on a comparison of an associated confidence value and a confidence threshold,
wherein the correlation signature type comprises a first correlation signature or a second correlation signature; and
wherein the filtered set of event correlation signatures is obtained by:
iteratively clustering the plurality of event correlation signatures into one or more groups, until a desired cluster size or one or more grouping criteria is reached, wherein the desired cluster size or the one or more grouping criteria for obtaining the one or more groups is based on one or more constraints further comprising at least one of an event direction, an event time window, an associated confidence, an associated size, and an entity relationship;
mapping each event correlation signature to at least one use case based on one or more properties of the one or more groups;
obtaining a feedback for the plurality of event correlation signatures comprised in the one or more groups; and
generating the filtered set of event correlation signatures by adjusting at least one of a time window, a confidence value, and a support based on the feedback.

19. The one or more non-transitory machine-readable information storage mediums of claim 18, wherein when the correlation signature type is the first correlation signature, the one or more hardware processors further cause:
identifying a set of pre-conditions based on one or more attributes of the plurality of events to obtain the one or more groups of correlation events, and wherein each group identifies a unique pre-conditional value; and
applying the set of pre-conditions on the one or more associated correlation signatures identified as the first correlation signature to increase the associated confidence value.

20. The one or more non-transitory machine-readable information storage mediums of claim 19, wherein when the correlation signature type is the second correlation signature, the one or more hardware processors further cause:
analyzing the second correlation signature based on a topology further comprising a plurality of entities and an associated entity type to increase a correlation support for the second correlation signature.
